(19) United States
(12) Patent Application Publication
(10) Pub. No.: US 2009/0061885 A1
(43) Pub. Date: Mar. 5, 2009

(54) SYSTEM AND METHOD FOR CONTAGIOUS VIRTUAL CARRIER SENSE

(75) Inventor: DONALD EGGLESTON EASTLAKE, III, MILFORD, MA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/845,197

(22) Filed: Aug. 27, 2007

(51) Int. Cl. H04Q 7/20

(52) U.S. Cl. 455/450

(57) ABSTRACT

At a first mobile station operating in the wireless communication system, channel usage information is observed and sensed on a first communication channel. The channel usage information is re-transmitted to a second mobile station that is operating in the wireless communication system.

### TECHNICAL FIELD

The technical field relates generally to mobile devices and more particularly to receiving and transmitting messages between mobile devices in wireless systems.

### BACKGROUND

Various types of communication systems such as Ethernet and Wireless Fidelity (WiFi) systems have been operated on a contention basis. More specifically, in these approaches, a mobile station listened for a carrier, waited to transmit if the carrier appeared to be busy, and transmitted messages only if the carrier appeared to be idle. In these systems, transmissions sometimes collided and these collisions proved detrimental to system performance because the messages that collided were lost.

Some systems attempted to reduce collisions by detecting whether the carrier was busy before a transmission was made. Unfortunately, carrier detection was often made difficult by the rapid decay of signal strength of mobile stations with distance. For example, a first mobile station may have attempted to transmit to a second mobile station even when a third mobile station was attempting to transmit to the second mobile station. In this case, the third mobile station may have been hidden from (i.e., was unaware of the existence of) the first mobile station (and vice versa). Additionally, sometimes there were obstructions blocking some communication paths further reducing the ability of one mobile station to detect signals from other mobile stations. As a result of these problems, the transmission and reception of communications in networks was often adversely affected in these previous systems.

Some previous systems attempted to overcome the above-mentioned problems by implementing virtual carrier sense algorithms. In these previous approaches, the transmitting mobile station sent an announcement including the identity of the intended recipient and the duration of the message. If the intended recipient successfully received the transmission, it transmitted an acceptance message. Thus, any station that was in range to receive either the announcement from the intended transmitting station or the acceptance from the intended receiving station was notified of the upcoming transmission. Unfortunately, mobile stations sometimes switched channels and, in that situation, the announcement messages were typically missed. Consequently, collisions between mobile stations still occurred.

Thus, there exists a need for virtual carrier sense transmission approaches, which address at least some of the shortcomings of past and present carrier sense techniques.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a block diagram of a virtual carrier sense system in accordance with some embodiments.

FIG. 2 is a call flow diagram of an approach for contagious virtual carrier sense in accordance with some embodiments.

FIG. 3 is a diagram showing communication channel usage in accordance with some embodiments.

FIG. 4 is a diagram showing another example of communication channel usage in accordance with some embodiments.

FIG. 5 is a diagram showing examples of Request to Transmit (RTX) and Clear to Transmit (CTX) in accordance with some embodiments.

FIG. 6 is a block diagram of a device for providing contagious virtual carrier sense in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, virtual carrier sense transmission approaches are provided that significantly reduce or eliminate collisions between mobile station transmissions in networks. Those skilled in the art will realize that the above recognized advantages and other advantages described herein are merely illustrative and are not meant to be a complete rendering of all of the advantages of the various embodiments.

In some of these embodiments, at a first mobile station operating in the wireless communication system, channel usage information is observed and sensed on a first communication channel. The channel usage information is re-transmitted to a second mobile station that is operating in the wireless communication system.

At the second mobile station, the channel usage information is received and a second communication channel is selected to transmit data based upon the channel usage information. The channel usage information may be re-transmitted to a third mobile station operating in the wireless communication system after a predetermined period of time.

The channel usage information may be re-transmitted over a second communication channel or over the first communication channel. Additionally, the channel usage information may also be stored and re-transmitted to the second mobile station after a predetermined period of time.

In some examples, the first communication channel may be a common control channel provided in the system. The channel usage information that is re-transmitted in a message may assume a number of forms. For example, the information may be transmitted as an announcement message; in a Request to Transmit (RTX) message; in a Clear to Transmit (CTX) message; in a Clear to Send (CTS) message; in a Request to Send (RTS) message; or in an Acknowledgement (ACK) message. Other types of messages can also be used to transmit the information.

The wireless communication system operates according to various standards. In one example, the wireless communication system operates according to an Institute of Electrical and Electronics Engineers (IEEE) 802.11-compliant standard. The communication system may operate according to other IEEE 802 or non-IEEE-802 wireless standards or protocols as well.

Thus, approaches are provided that significantly reduce or eliminate the number of collisions between transmitting mobile devices in wireless networks. The approaches are easy to use, and improve system performance (e.g., significantly reduce or eliminate dropped messages).

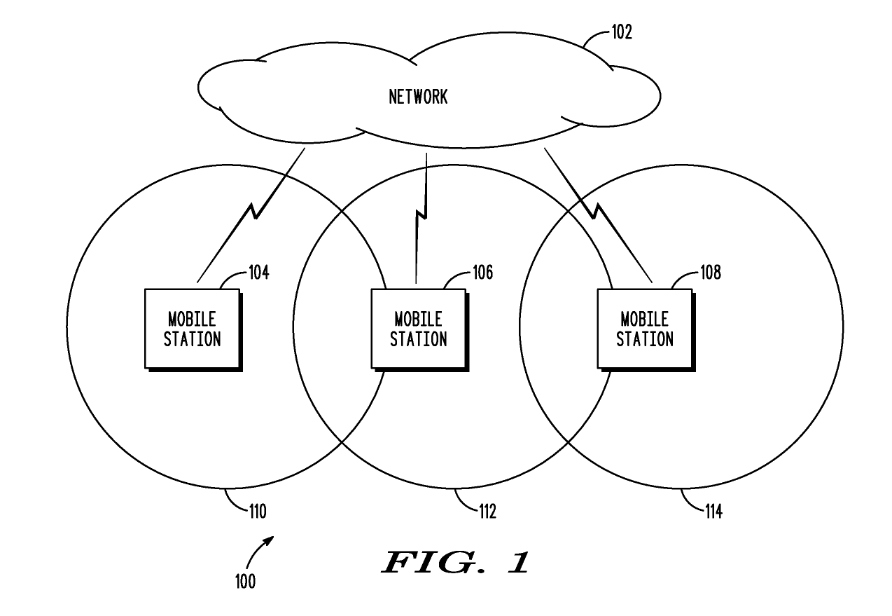

Turning now to FIG. 1, a system that utilizes contagious virtual carrier sense approaches to reduce transmission collisions is shown and generally indicated at reference number 100. The system 100 includes a first mobile station 104, a second mobile station 106, and a third mobile station 108. The first mobile station 104 is able to transmit and receive messages within a first operating range 110. The second mobile station 106 is able to transmit and receive messages within a second operating range 112. The third mobile station 108 is able to transmit and receive messages within a third operating range 114. As shown, the first operating range 110 overlaps with the second operating range 112 and the second operating range 112 overlaps with the third operating range 114. However, the first operating range 110 does not overlap with the third operating range 114. In this example, the first mobile station 104 is aware of the second mobile station 106, and the second mobile station 106 is aware of the third mobile station 108. However, the first mobile station 104 is not aware of the third mobile station 108.

The first mobile station 104, second mobile station 106, and third mobile station 108 communicate with a network 102. The network 102 may be any network or combination of networks such as the Internet, cellular networks, or wireless local area networks. Additionally, the first mobile station 104, second mobile station 106, and third mobile station 108 may be any type of wireless mobile communication device such as cellular phones, pagers, personal digital assistants, or personal computers. Other examples of networks and mobile stations are possible.

In one example of the operation of the system of FIG. 1, at the first mobile station 104 operating in the wireless communication system 100, channel usage information is observed and sensed on a first communication channel. The channel usage information is re-transmitted to the second mobile station 106 that is operating in the wireless communication system. The channel usage information may indicate the identity of channels that are in use (e.g., transmitting other messages or data). The channel usage information may also include the durations of messages or data of the channels that are in use.

At the second mobile station 106, the channel usage information is received and a second communication channel is selected to transmit data based upon the channel usage information. The channel usage information may also be re-transmitted to the third mobile 108 station operating in the wireless communication system 100 after a predetermined period of time expires.

The channel usage information may be re-transmitted over a different second communication channel or over the same first communication channel. As mentioned, the channel usage information may also be stored and re-transmitted to the second mobile station 106 after a predetermined period of time.

The first communication channel may be a common control channel. The channel usage information that is re-transmitted in a message may be sent in an announcement message, a Request to Transmit (RTX) message, a Clear to Transmit (CTX) message, a Clear to Send (CTS) message, a Request to Send (RTS) message, or an Acknowledgement (ACK) message. Other types of messages may also be used to transmit the information.

The wireless communication system 100 operates according to various standards or protocols. In one example, the wireless communication system operates according to an IEEE 802.11-compliant standard. The system 100 may operate according to other types of standards or protocols as well.

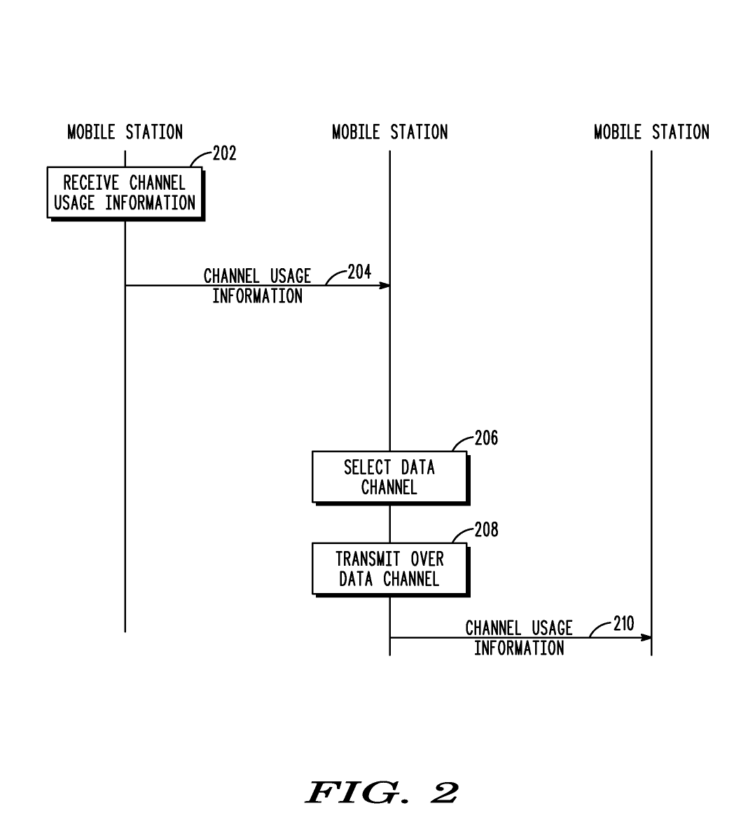

Referring now to FIG. 2, one example of an approach for avoiding collisions using contagious virtual carrier sense approaches is described. At 202, a first mobile station receives channel usage information. The channel usage information may indicate the identity of channels that are or will be in use (e.g., transmitting or planning to transmit other messages or data). The channel usage information may also include the durations of messages or data of the channels that are or will be in use.

At 204, the channel usage information is transmitted from the first mobile station to a second mobile station. In one example, the information may be transmitted over a common control channel. In other examples, the information may be transmitted over data channels. The message transmitted may include information concerning other busy channels. For example, if a channel were busy, an indication of this busy state may be included in the message.

At 206, the second mobile station selects a data channel. With this step, the second mobile station utilizes the channel usage information it has received to select a data channel that is not in use. At 208, the second mobile station transmits data over the data channel. At 210, the second mobile station transmits channel usage information to a third mobile station. As before, the channel usage information can indicate the channels that the second mobile station knows are or will be in use. It may also include re-transmitting other messages (e.g., virtual carrier announcement messages).

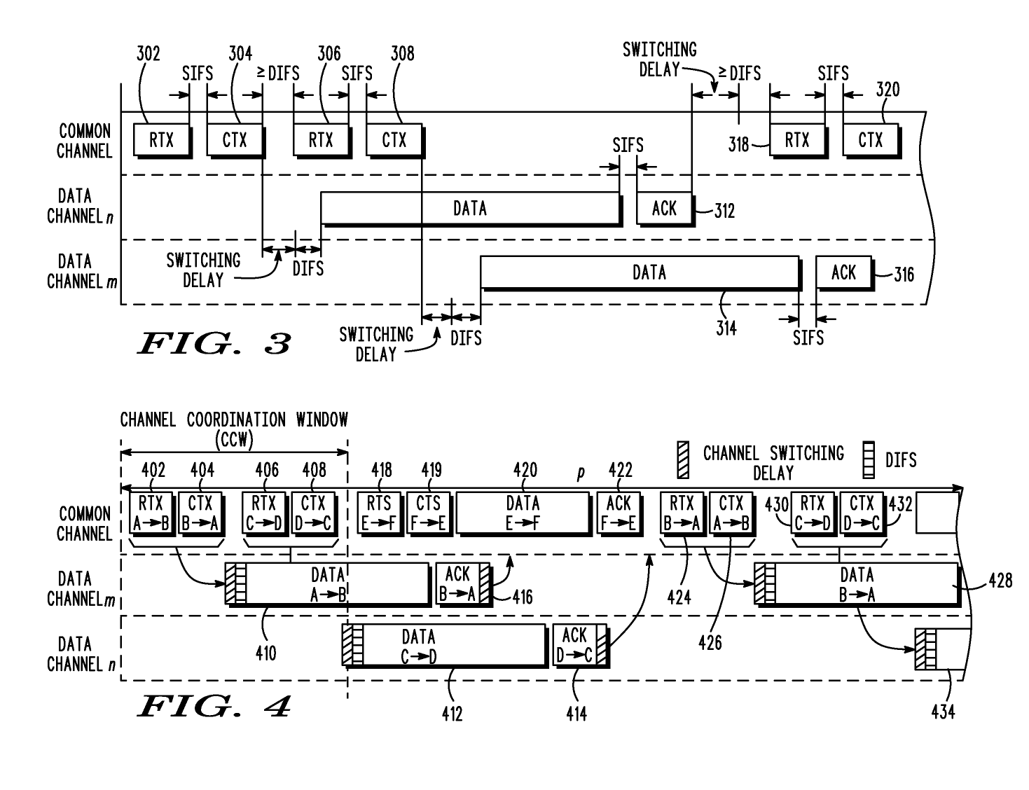

Referring now to FIG. 3, another example of an approach for avoiding transmission collisions using contagious virtual carrier sense approaches is described. As shown, the system utilizes a common channel, a data channel n, and a data channel m. In this example, RTX messages are sent from a transmitting mobile station and CTX messages may be sent (in response to the RTX messages) by receiving mobile stations.

At 302, a first RTX (Request to Transmit with extra channel switching and contagious virtual carrier sense information) message is sent on the common channel. The first RTX may include information concerning other busy channels. For example, if the m channel was busy, identification of the m channel may be included in the message. The first RTX message may also include the duration of any channel usage of the busy channel.

At 304 (after a Short Inter-frame Space (SIFS) delay), a first CTX (Clear to Transmit with extra information) message is sent on the common channel. The first CTX message may include information concerning other channels that are busy. For example, if the m channel was busy, identification of the m channel as being busy may be included in the message. Additionally, the first CTX message may include the duration of any channel usage of the busy channel.

At 306, a second RTX message is sent over the common channel. As before, the second RTX message may include information concerning other channels that are busy. For example, based on its observation of the first RTX and CTX, the station sending the second RTX may announce that channel n is about to be busy. Additionally, the second RTX message may also include the duration of any channel usage of the busy or anticipated to be busy channel.

At 308 (after a Short Inter-frame Space (SIFS) delay), a second CTX message is sent. As before, the second CTX message may include information concerning other busy channels. For example, if the n channel were busy, an indication may be included in the message. Additionally, as before, the second CTX may include the duration of any channel usage of the busy or anticipated to be busy channel.

Between 304 and 310, agreement between the first RTX and first CTX as to what channel to use for the first data transmission causes the station sending the first RTX and the responding station sending the first CTX to switch to that channel causing a switching delay and a distributed control function Inter-frame space (DIFS) occur. At 310, data is placed on data channel n. An SIFS delay then occurs. At 312, a first Acknowledgement (ACK) message is sent.

Between 308 and 314, agreement between the second RTX and second CTX as to what channel to use for the second data transmission causes the station sending the second RTX and the responding station sending the second CTX to switch to that channel causing a switching delay and a DIFS occur. At 314, data is placed on data channel m. An SIFS delay then occurs. At 316, a second ACK is placed on data channel m.

At 318, a third RTX message is sent on the common channel and at 320 a third CTX message is sent on the common channel. A switching delay and a time delay greater than or equal to DIFS occurs between 312 and 318 if the station sending the third RTX was a station involved in 310 or 312. As before, channel usage information can be included in these messages.

By including the channel usage information in the RTX or CTX messages, spectral contagion is provided by reporting on the common channel transmission announcements seen on other channels that were missed by the mobile station either because a mobile station was temporarily tuned to another channel or because, for example, the mobile station had multiple radios but was monitoring another channel or channels.

Additionally (or as an alternate to spectral contagion), temporal contagion may also be provided by retransmitting on the common channel previously transmitted information. More specifically, a mobile station may wait for a predetermined amount of time to retransmit the information to other mobile stations.

In other examples, a mobile station can send an announcement when there is no need to send a CTX or RTX message. In this case, a new virtual carrier sense announcement message may be defined and broadcast (e.g., over the common channel) or a dummy CTX may be send by a mobile station with itself being the destination node.

Referring now to FIG. 4, one example of an approach for contagious virtual carrier sense is described. FIG. 4 shows an example similar to FIG. 3 except that RTS and CTS messages without channel switching information are used to effect agreement between two stations for a data transfer on a common channel. In this example, six mobile stations (a mobile station A, a mobile station B, a mobile station C, a mobile station D, a mobile station E, and a mobile station F) are operating. Some of these mobile stations are hidden from the others. Between messages, various switching delays and distributed control function Inter-frame spaces are transmitted/occur as shown in the figure. Additionally, in this example, the system can utilize both RTS/CTS and RTX/CTX messaging approaches.

At 402, an RTX (Request to Transmit with extra channel switching and contagious virtual carrier sense information) message (from the mobile station A to the mobile station B) is sent on the common channel. At 404, a CTX (Clear to Transmit with extra information) message is placed on the common channel and sent from the mobile station B to the mobile station A). The RTX and CTX messages may include information concerning other busy channels. For example, if the m channel were busy an indication may be included in the message. Additionally, the RTX and CTX messages may include the duration of any channel usage.

At 406, an RTX (from the mobile station C to the mobile station D) is sent on the common channel. At 408, a CTX message (from the mobile station D to the mobile station C) is sent on the common channel. As before, the RTX and CTX messages may include information concerning other busy channels. For example, based on its observation of the first RTX and CTX, the station sending the second RTX may announce that the n channel is about to be busy. Additionally, the RTX and CTX messages may include the duration of any channel usage or anticipated channel usage.

At 410, data (from the mobile station A to the mobile station B) is sent on channel m. At 412, data is sent on channel n (from the mobile station C to the mobile station D). At 414, an acknowledgment is sent on channel n (from the mobile station D to the mobile station C). At 416, an ACK is sent on channel m (from the mobile station B to the mobile station A).

At 418, an RTS message is sent from the mobile station E to mobile station F. At 419, a CTS message is sent from the mobile station F to the mobile station E. At 420, data is sent over the common channel from the mobile station E to the mobile station F. At 422, an ACK message is sent from mobile station F to the mobile station E over the common channel. The RTS and CTS messages may include information concerning other busy channels or anticipated to be busy channels. For example, if the m channel were busy an indication may be included in the message. Additionally, the RTS and CTS messages may include the duration of any channel usage.

At 424, an RTX is sent from the mobile station B to the mobile station A over the common channel. At 426, a CTX is sent from the mobile station A to the mobile station B over the common channel. At 428 data is sent from the mobile station B to the mobile station A. At 430, an RTX message is sent from the mobile station C to the mobile station D. At 432, a CTX from the mobile station D to the mobile station C is sent on the common channel. At 434, data is sent from the mobile station C to the mobile station D over the channel n. As before, any of the RTX and CTX messages may include information concerning other busy channels or anticipated to be busy channels. For example, if the m channel were busy an indication may be included in the message. Additionally, any of the RTX and CTX messages may include the duration of any channel usage or anticipated channel usage.

As with the example of FIG. 3, a mobile station can send an announcement when there is no need to send a CTX, CTS, RTX, or RTS message. In this case, a new virtual carrier sense announcement message may be defined and broadcast (e.g., over the common channel) or a dummy CTX or CTS message may be send by a mobile station with itself being the destination node.

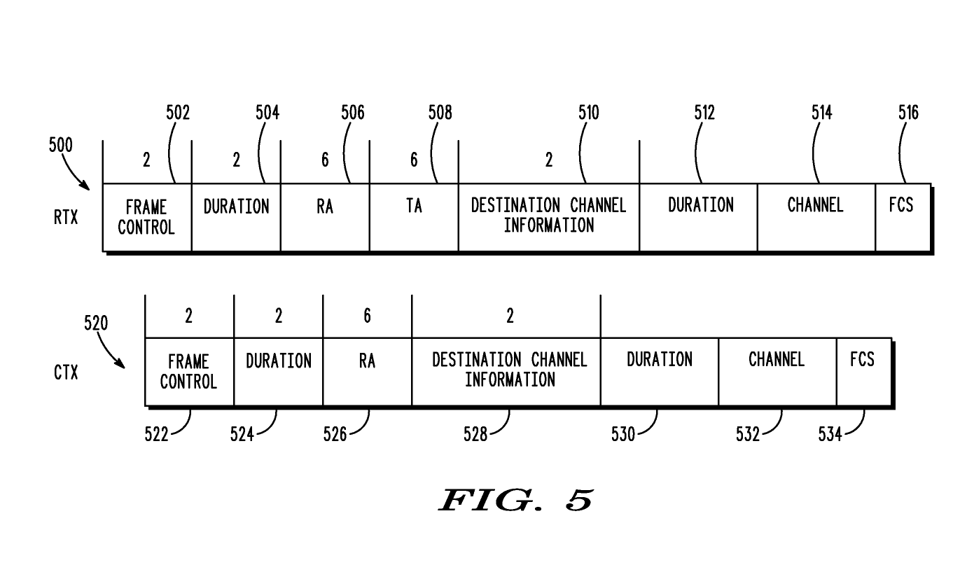

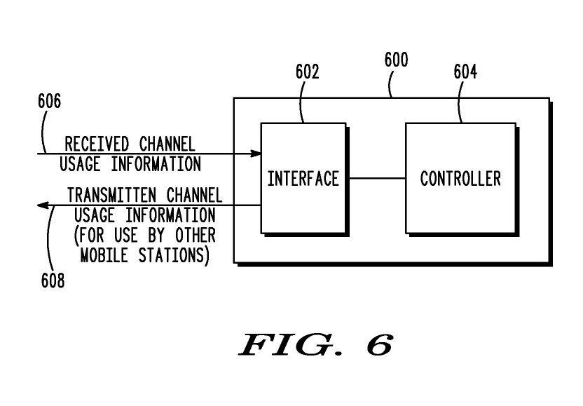

Referring now to FIG. 5, one example of CTX 520 and RTX 500 messages are described. The RTX message 500 includes a frame control field 502, a duration field 504, a receiver address (RA) field 506, a transmitter address (TA) field 508, a destination channel information field 510, an announcement duration field 512, an announcement channel field 514 and a Frame Check Sum (FCS) field 516.

The frame control field 502 indicates control information for the frame. The RA field 506 includes the address of the receiving mobile station and the TA field 508 includes the address of the transmitting mobile station. The FCS field 516 includes a checksum and may be used to detect if the message has been received ungarbled. The duration field 504 indicates the duration of data to be transmitted. The destination channel field 510 indicates the channel on which the message is to be sent. The announcement channel field 514 indicates the channel that is being used/busy. The announcement duration field 512 indicates the duration of the data/information on the channel indicated by the announcement channel field 514.

The CTX message 520 includes a frame control field 522, a duration field 524, an RA field 526, a destination channel information field 528, an announcement duration field 530, an announcement channel field 532 and an FCS field 534. The frame control field 522 indicates control information for the frame. The RA field 526 includes the address of the receiving mobile station. The FCS field 534 includes a checksum that can be used to detect if the message has been received ungarbled. The duration field 524 indicates the duration of data to be transmitted. The destination channel information field 528 indicates the channel on which the message is to be sent. The announcement channel field 532 indicates the channel that is being used/busy. The announcement duration field 530 indicates the duration of the data/information on the channel indicated by the announcement channel field 532.

As one skilled in the art would appreciate, the RTX and CTX messages in the examples presented herein could also list multiple channels in the channel field and give multiple corresponding durations in the duration field.

Referring now to FIG. 6, one example of a device 600 that provides contagious virtual carrier sense capabilities is described. The device 600 includes an interface 602 and a controller 604. In one example, the device 600 is a mobile station, wherein the interface further comprises any suitable wireless receiver and transmitter apparatus, and the controller comprises any suitable processing device.

The interface 602 has an input and output and is arranged and configured to receive wirelessly-transmitted channel usage information on a first communication channel at 606 the input. The controller 604 is arranged and configured to re-transmit the channel usage information to at least one other mobile station at the output of the interface.

In some examples, the controller 604 is further arranged and configured to re-transmit the channel usage information over a second communication channel 608 at the output of the interface 602. The controller 604 may be further arranged and configured to re-transmit the channel usage information over the first communication channel at the output of the interface 602.

The device 600 may also include a memory and the controller 604 may be further arranged and configured to store the channel usage information in the memory and re-transmit the channel usage information after a predetermined period of time.

Thus, approaches are provided that significantly reduce or eliminate the number of collisions between transmitting mobile devices in wireless networks. The approaches are easy to use, and improve system performance by significantly reducing or eliminating dropped or delayed calls or other communications.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for described herein. The non-processor circuits may include, but are not limited to, a radio receiver, a radio transmitter, signal drivers, clock circuits, power source circuits, and user input devices. As such, these functions may be interpreted as steps of a method to perform the described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for propagating information in a wireless communication system comprising:
at a first mobile station operating in the wireless communication system:
receiving channel usage information on a first communication channel; and
re-transmitting the channel usage information to a second mobile station that is operating in the wireless communication system.

2. The method of claim of claim 1 further comprising:
at the second mobile station:
receiving the channel usage information; and
selecting a second communication channel to transmit data based upon the channel usage information.

3. The method of claim 2 further comprising:
at the second mobile station:
re-transmitting the channel usage information to a third mobile station operating in the wireless communication system after a predetermined period of time.

4. The method of claim 1 wherein re-transmitting the channel usage information comprises re-transmitting the channel usage information over a second communication channel.

5. The method of claim 1 wherein re-transmitting the channel usage information comprises re-transmitting the channel usage information over the first communication channel.

6. The method of claim 1 further comprising storing the channel usage information and wherein re-transmitting the channel usage information comprises re-transmitting the information to the second mobile station after a predetermined period of time.

7. The method of claim 1 wherein the first communication channel comprises a common control channel.

8. The method of claim 1 wherein the channel usage information is re-transmitted in a message selected from a group comprising: an announcement message; a Request to Transmit (RTX) message; a Clear to Transmit (CTX) message; a Clear to Send (CTS) message; a Request to Send (RTS) message; and an Acknowledgement (ACK) message.

9. The method of claim 1 wherein the wireless communication system operates compliant to an Institute of Electrical and Electronics Engineers (IEEE) 802.11 standard.

10. A method of propagating information in a wireless communication system comprising:
at a mobile station operating in the wireless communication system:
receiving channel usage information on a common control channel;
storing the channel usage information for later use;
selectively re-transmitting the channel usage information on the common control channel; and
selecting a data communication channel to transmit data based upon content of the channel usage information.

11. The method of claim 10 wherein the common control channel and the data channel are the same channel.

12. The method of claim 10 wherein the common control channel and the data channel are different channels.

13. The method of claim 10 wherein selectively re-transmitting comprises selectively re-transmitting the channel usage information after a predetermined period of time.

14. A mobile station comprising:
an interface having an input and output, the interface arranged and configured to receive wirelessly-transmitted channel usage information on a first communication channel at the input; and
a controller coupled to the interface, the controller arranged and configured to re-transmit the channel usage information to at least one other mobile station at the output of the interface.

15. The mobile station of claim 14 wherein the controller is further arranged and configured to re-transmit the channel usage information over a second communication channel at the output of the interface.

16. The mobile station of claim 14 wherein the controller is further arranged and configured to re-transmit the channel usage information over the first communication channel at the output of the interface.

17. The mobile station of claim 14 further comprising a memory and wherein the controller is further arranged and configured to store the channel usage information in the memory and re-transmit the channel usage information after a predetermined period of time.

18. The mobile station of claim 14 wherein the first communication channel comprises a common control channel.

19. The mobile station of claim 14 wherein the channel usage information is transmitted in a message selected from a group comprising: an announcement message; a Request to Transmit (RTX) message; a Clear to Transmit (CTX) message; a Clear to Send (CTS) message; a Request to Send (RTS) message; and an Acknowledgement (ACK) message.
